(19) United States
(12) Patent Application Publication
(10) Pub. No.: US 2026/0333505 A1
(43) Pub. Date: Oct. 22, 2026

(54) COMMUNICATION METHOD, USER EQUIPMENT, AND NETWORK NODE

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/578,698

(22) Filed: Mar. 25, 2026

Related U.S. Application Data
(63) Continuation of application No. PCT/JP2024/034210, filed on Sep. 25, 2024.
(60) Provisional application No. 63/540,274, filed on Sep. 25, 2023.

(51) Int. Cl. H04W 76/27; H04W 76/40

(52) U.S. Cl. CPC H04W 76/27; H04W 76/40

(57) ABSTRACT

A communication method executed by a user equipment in a mobile communication system for providing a multicast broadcast service (MBS) includes: receiving, from a network node, prohibition period information and/or network congestion level information for determining whether starting a radio resource control (RRC) connection resume procedure related to a multicast session is allowed; determining whether to start the RRC connection resume procedure based on the prohibition period information and/or the network congestion level information in an RRC inactive state; and starting the RRC connection resume procedure for the network node when determining to start the RRC connection resume procedure.

### RELATED APPLICATIONS

The present application is a continuation based on PCT Application No. PCT/JP2024/034210, filed on Sep. 25, 2024, which claims the benefit of U.S. Provisional Application No. 63/540274 filed on Sep. 25, 2023. The content of which is incorporated by reference herein in their entirety.

### TECHNICAL FIELD

The present disclosure relates to a communication method, a user equipment, and a network node used in a mobile communication system.

### BACKGROUND

In the 3rd generation partnership project (3GPP) (registered trademark; the same applies hereinafter), a technical specification of new radio (NR), which is a fifth-generation (5G) radio access technology, is defined. NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR.

In 3GPP Release 17, MBS multicast reception (i.e., multicast reception) is possible only for a user equipment in a radio resource control (RRC) connected state (see, for example, Non-Patent Document 1). On the other hand, in 3GPP Release 18, technical specifications are scheduled to be extended so that a user equipment in an RRC inactive state can perform multicast reception.

### CITATION LIST

### Non-Patent Literature

Non-Patent Literature 1:3GPP Technical Specification: TS 38.300 V 17.5.0

### SUMMARY

A communication method according to a first aspect is a communication method executed by a user equipment in a mobile communication system for providing a multicast broadcast service (MBS), the communication method including: receiving, from a network node, prohibition period information and/or network congestion level information for determining whether starting a radio resource control (RRC) connection resume procedure related to a multicast session is allowed; determining whether to start the RRC connection resume procedure based on the prohibition period information and/or the network congestion level information in the RRC inactive state; and starting the RRC connection resume procedure for the network node when determining to start the RRC connection resume procedure.

A user equipment according to a second aspect is a user equipment used in a mobile communication system for providing a multicast broadcast service (MBS), the user equipment including: a receiver configured to receive, from a network node, prohibition period information and/or network congestion level information for determining whether starting a radio resource control (RRC) connection resume procedure related to a multicast session is allowed; and a controller configured to determine whether to start the RRC connection resume procedure based on the prohibition period information and/or the network congestion level information in an RRC inactive state. When determining to start the RRC connection resume procedure, the controller starts the RRC connection resume procedure for the network node.

A communication method according to a third aspect is a communication method executed by a network node in a mobile communication system for providing a multicast broadcast service (MBS), the communication method including:
managing priority information in which information indicating a priority of the multicast reception of a user equipment is associated with an identifier assigned to the user equipment; transmitting, to the user equipment, an RRC release message causing the user equipment to transition to a radio resource control (RRC) inactive state and including the identifier;
receiving, from the user equipment, the RRC resume request message including the identifier; and
determining whether to accept an RRC resume request of the user equipment based on the identifier included in the RRC resume request message and the priority information.

A network node according to a fourth aspect is a network node used in a mobile communication system for providing a multicast broadcast service (MBS), the network node including: a controller configured to manage priority information in which information indicating a priority of the multicast reception of a user equipment is associated with an identifier assigned to the user equipment; a transmitter configured to transmit, to the user equipment, an RRC release message causing the user equipment to transition to a radio resource control (RRC) inactive state and including the identifier; and a receiver configured to receive, from the user equipment, the RRC resume request message including the identifier, in which the controller determines whether to accept an RRC resume request of the user equipment based on the identifier included in the RRC resume request message and the priority information.

### BRIEF DESCRIPTION OF THE DRAWINGS

FIG. 1 is a diagram illustrating a configuration example of a mobile communication system according to an embodiment.

FIG. 2 is a diagram illustrating a configuration example of a user equipment (UE) according to an embodiment.

FIG. 3 is a diagram illustrating a configuration example of a gNB (network node) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a first example of a ping-pong phenomenon.

FIG. 7 is a diagram illustrating a second example of the ping-pong phenomenon.

FIG. 8 is a diagram illustrating a third example of the ping-pong phenomenon.

FIG. 9 is a diagram illustrating an overview of an operation of a UE according to an embodiment.

FIG. 10 is a diagram illustrating an example of a first operation pattern of a mobile communication system according to an embodiment.

FIG. 11 is a diagram illustrating an example of a second operation pattern of the mobile communication system according to an embodiment.

FIG. 12 is a diagram illustrating an overview of an operation of a gNB according to another embodiment.

FIG. 13 is a diagram illustrating an example of an operation of a mobile communication system according to another embodiment.

### DESCRIPTION OF EMBODIMENTS

According to an embodiment, a mobile communication system is described with reference to the drawings. In the description of the drawings, the same or similar parts are denoted by the same or similar reference signs.

### (1) System Configuration Example

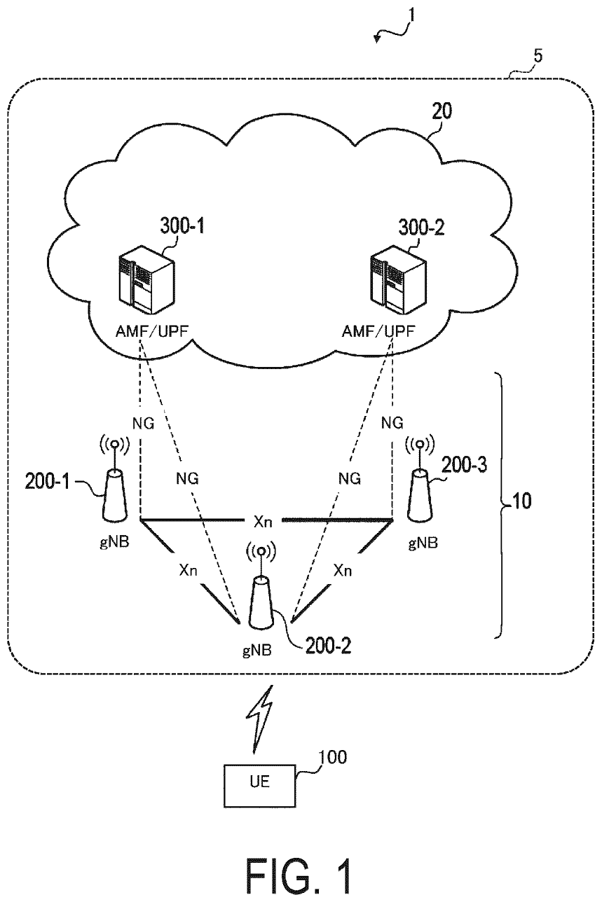

FIG. 1 is a diagram illustrating a configuration example of a mobile communication system 1 according to the embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 configure a network 5 of the mobile communication system 1.

The UE 100 is a mobile wireless communication apparatus. The UE 100 may be any apparatus when the apparatus is an apparatus that is used by a user, and for example, the UE 100 may be a mobile phone terminal (including a smartphone), a tablet terminal, a laptop PC, a communication module (including a communication card or a chipset), a sensor or an apparatus provided in a sensor, a vehicle or an apparatus provided in a vehicle (vehicle UE), or an aerial object or an apparatus provided in an aerial object (aerial UE).

The NG-RAN 10 includes a base station 200, which is a type of network node (referred to as a gNB in a 5G system). The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

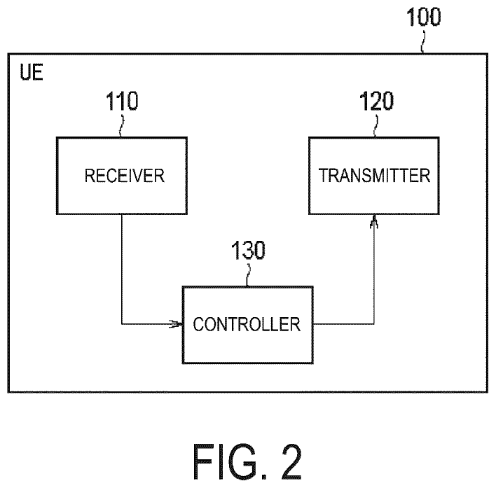

FIG. 2 is a diagram illustrating a configuration example of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The operations of the UE 100 described above and below may be operations under the control of a controller 230. The controller 130 includes at least one processor and at least one memory. The memory stores a program to be executed by the processor and information to be used for processing in the processor. The processor may include a baseband processor and a central processing unit (CPU). The baseband processor performs modulation and demodulation, coding and decoding, and the like of a baseband signal. The CPU executes the program stored in the memory to thereby perform various types of processing.

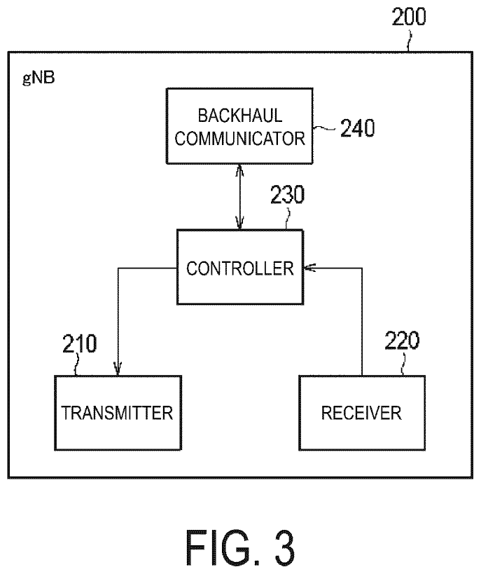

FIG. 3 is a diagram illustrating a configuration example of a gNB 200 (network node) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The operations of the gNB 200 described above and below may be also performed under the control of the controller 230. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface which is an interface between a base station and the core network. Note that the gNB 200 may include a Central Unit (CU) and a Distributed Unit (DU) (i.e., functions are divided), and both units may be connected via an F1 interface that is a fronthaul interface.

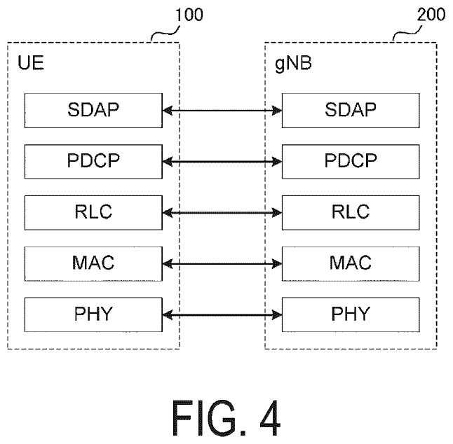

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. Cyclic redundancy code (CRC) parity bits scrambled by an RNTI is applied to the DCI transmitted from the gNB 200.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

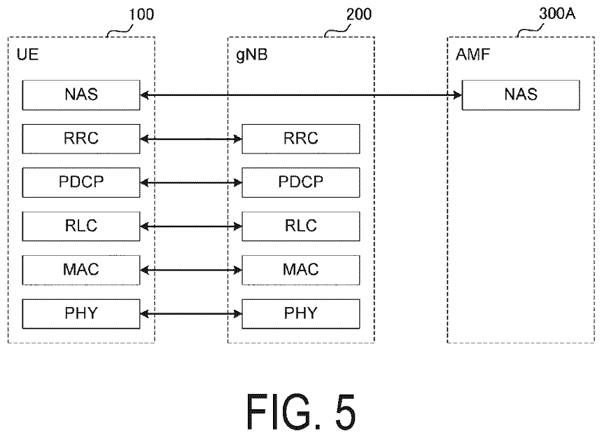

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between RRC of the UE 100 and RRC of the gNB 200, the UE 100 is in an RRC connected state. When connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also simply referred to as “NAS”), which is located above the RRC layer, performs session management, mobility management, and the like. NAS signaling is transmitted between the NAS layer of the UE 100 and the NAS layer of an AMF 300A. The UE 100 includes an application layer other than the protocol of the radio interface. The layer below the NAS layer is referred to as an AS layer (also simply referred to as “AS”).

### (2) Overview of MBS

The mobile communication system 1 can perform delivery with high resource efficiency by using the multicast/broadcast service (MBS).

### (2.1) MBS Broadcast

In a case of the broadcast communication services (also referred to as “MBS broadcast”), the same service and the same specific content data are provided simultaneously to every UE 100 in a geographic area. That is, every UE 100 in the broadcast service area is permitted to receive the data. The broadcast communication services are delivered to the UE 100 using a broadcast session that is a type of MBS session. The UE 100 can receive the broadcast session in any state of the RRC idle state, the RRC inactive state, and the RRC connected state.

Point-to-Multipoint (PTM) delivery is applied to the broadcast communication service. For the PTM transmission, the gNB 200 delivers a single copy of an MBS packet to a set (group) of a plurality of UEs 100. For example, the gNB 200 schedules a group-common PDSCH scrambled by a G-RNTI using a group-common PDCCH having a CRC scrambled by the group RNTI (G-RNTI), which is a group-common RNTI.

For the broadcast communication service, the UE 100 receives a broadcast session in the following procedure. First, the UE 100 receives system information block type 20 (SIB20) from the gNB 200. The SIB20 includes a configuration of a multicast control channel (MCCH), which is a type of logical channel. Second, the UE 100 receives the MCCH from the gNB 200 based on the SIB20. The MCCH includes a PTM configuration. The PTM configuration transmits a configuration for a multicast traffic channel (MTCH) (MTCH configuration), which is a type of logical channel, and a configuration of a broadcast multicast radio bearer (MRB), which is an MRB for broadcast session. The information transmitted by the MCCH may be referred to as MBS broadcast control information. Third, the UE 100 receives the MTCH based on the MCCH. The MTCH transmits a broadcast session (specifically, MBS data belonging to the broadcast session).

An MCCH is a PTM downlink channel for transmitting MBS broadcast control information associated with one or more MTCHs from the network 5 to the UE 100. An MTCH is a PTM downlink channel for transmitting MBS data of either a multicast session or a broadcast session from the network 5 to the UE 100.

### (2.2) MBS Multicast

For a multicast communication service (also referred to as “MBS multicast”), the same service and the same specific content data are simultaneously provided to a specific UE set. That is, not every UE 100 in the multicast service area is permitted to receive data. The multicast communication service is delivered to the UE 100 using a multicast session that is a type of MBS session.

The UE 100 can receive a multicast session only after joining the multicast session (session join). The joining the multicast session may mean that the UE 100 is registered as being capable of receiving the multicast session in the network 5 (the CN 20).

For the multicast communication service, in 3GPP Release 17, only the UE 100 in the RRC connected state can receive a multicast session. On the other hand, in 3GPP Release 18, the specifications are extended such that the UE 100 in an RRC inactive state is also capable of receiving a multicast session.

### (2.2.1) Multicast Reception in RRC Connected State

The UE 100 in the RRC connected state can receive a multicast session (specifically, MBS data belonging to a multicast session) by using mechanisms such as Point-to-Point (PTP) delivery and/or Point-to-Multipoint (PTM) delivery.

For the multicast communication service, the UE 100 in the RRC connected state receives a multicast session in the following procedure. First, the UE 100 receives an RRC Reconfiguration message from the gNB 200. The RRC Reconfiguration message is a message transmitted on a dedicated control channel (DCCH). The RRC Reconfiguration message transmits a configuration for an MTCH for multicast session reception (MTCH configuration) and a configuration of a multicast MRB which is an MRB for multicast session. Second, the UE 100 receives an MTCH based on the RRC Reconfiguration message. The MTCH transmits a multicast session (specifically, MBS data belonging to the multicast session).

### (2.2.2) Multicast Reception in RRC Inactive State

The UE 100 in the RRC inactive state may receive a multicast session (specifically, MBS data belonging to the multicast session) by using the mechanism of the PTM delivery.

For the multicast communication service, the UE 100 in the RRC inactive state can receive a multicast session in the following procedure. First, the UE 100 in the RRC inactive state receives a newly introduced system information block (also referred to as a “SIBx”) from the gNB 200. SIBx includes a configuration of a newly introduced MCCH (also referred to as a “multicast MCCH”). Second, the UE 100 in the RRC inactive state receives a multicast MCCH based on SIBx from the gNB 200. The multicast MCCH includes a PTM configuration. The PTM configuration transmits a configuration regarding an MTCH for multicast session reception (MTCH configuration) and a configuration of a multicast inactive MRB which is an MRB for multicast session reception in the RRC inactive state (multicast inactive MRB configuration). The MTCH configuration may be included in the multicast inactive MRB configuration. Third, the UE 100 in the RRC inactive state receives an MTCH based on the multicast MCCH. The MTCH transmits a multicast session, specifically, MBS data belonging to the multicast session(that is, multicast data).

When the gNB 200 configures the UE 100 to receive a multicast session in the RRC inactive state, the gNB 200 can transmit the PTM configuration (multicast inactive MRB configuration) to the UE 100 using an RRC release message including a suspend configuration. In this case, when the UE 100 receives the RRC release message including the PTM configuration from the gNB 200, the UE 100 transitions to the RRC inactive state and performs reception of the multicast session (multicast reception) in the RRC inactive state.

### (2.2.3) Group Notification

In a case in which there temporarily is no data to transmit to the UE 100 in the activated multicast session, the gNB 200 may cause the UE 100 to transition to the RRC inactive state. When the multicast session is deactivated, the gNB 200 may cause the UE 100 to transition to the RRC idle state or the RRC inactive state.

The gNB 200 supporting the MBS notifies the UE 100 in the RRC idle state or the RRC inactive state by using a group notification mechanism when the multicast session is activated by the CN 20. The gNB 200 that supports MBS may perform a notification to the UE 100 in the RRC inactive state using a group notification mechanism when a multicast session has been activated and the gNB 200 has multicast session data to deliver.

Upon receiving the group notification, the UE 100 reconnects to the network 5 or resumes the connection to transition to the RRC connected state. The group notification is processed with a paging RNTI (P-RNTI) on the PDCCH, and a paging channel is monitored by the UE 100.

A paging message used for the group notification includes session identifiers (MBS session IDs) for paging all UEs 100 in the RRC idle state and the RRC inactive state that have joined the associated MBS multicast session. That is, the UE 100 is not individually paged.

When the UE 100 transitions to the RRC connected state, the UE 100 may stop monitoring the group notification associated with the particular multicast session. That is, the UE 100 stops checking the MBS session ID in the paging message. The UE 100 does not monitor the group notification in a case in which the UE 100 leaves the multicast session, the network 5 requests the UE 100 to leave the multicast session, or the network 5 releases the multicast session.

Note that the group notification may be performed on the MCCH or may be performed with an MCCH Change Notification. In the case of using the MCCH, the determination may be made depending on whether the MTCH configuration of the MBS session of interest is present in the MCCH. In a case of using the MCCH Change Notification, the group notification may be made in a predetermined bit of the DCI.

### (3)Operation of Mobile Communication System

An operation of the mobile communication system 1 according to an embodiment will be described.

### (3.1) Overview of Operation

In the embodiment, a scenario is assumed in which the UE 100 in the RRC inactive state starts the RRC connection resume (also referred to as “RRC Resume”) in association with the multicast session (multicast reception). Here, the case in which the UE 100 in the RRC inactive state starts the RRC connection resume in association with the multicast session is a case in which reception quality during multicast reception at the UE 100 is poor, and/or a case in which the UE 100 needs to acquire multicast reception configuration (PTM configuration) from the gNB 200. In the embodiment, a scenario is mainly assumed in which the UE 100 starts the RRC connection resume in response to poor reception quality during the multicast reception in the UE 100 in the RRC inactive state.

The case in which reception quality during multicast reception at the UE 100 is poor is a case in which reference signal received power (RSRP) measured for the serving cell by the UE 100 is worse than an RSRP threshold value configured for the UE 100 from the network 5, and/or a case in which reference signal received quality (RSRQ) measured for the serving cell by the UE 100 is worse than an RSRQ threshold value configured for the UE 100 by the network 5. However, the case in which reception quality during multicast reception at the UE 100 is poor is may be a case in which a bit error rate (BER) measured for a multicast session by the UE 100 exceeds a BER threshold value configured for the UE 100 by the network 5, and/or a case in which a block error rate (BLER) measured for the multicast session by the UE 100 exceeds a BLER threshold value configured for the UE 100 from the network 5.

A threshold value to be compared with the reception quality during the multicast reception may be configured by the PTM configuration (multicast reception configuration) on an MBS session basis by the network 5 (gNB 200) for the UE 100 using the RRC release message or the multicast MCCH (multicast MCCH message). In the embodiment, when reception quality of a serving cell is worse than a threshold value configured by the network 5, the UE 100 that performs multicast reception in the RRC inactive state starts an RRC connection resume procedure.

The case in which the UE 100 needs to acquire the multicast reception configuration from the gNB 200 may be a case in which the UE 100 has not received the multicast reception configuration of the multicast session participated in by the UE 100 in the RRC release message, and the serving cell has not provided the multicast reception configuration via the multicast MCCH, that is, the UE 100 has received a paging message (group indication) indicating activation of the multicast session from the serving cell. The case in which the UE 100 needs to acquire the multicast reception configuration from the gNB 200 may be a case in which the UE 100 performs cell reselection from the first cell to the second cell, that is, the second cell (the reselected cell) does not provide the multicast reception configuration of the multicast session participated by the UE 100 via the multicast MCCH.

In the embodiment, a scenario is mainly assumed in which reception quality in the UE 100 that performs multicast reception in the RRC inactive state is worse than the threshold value configured by the network 5. In such a scenario, a ping-pong phenomenon may occur in which an RRC connection resume procedure and an RRC release procedure are repeated within a short time.

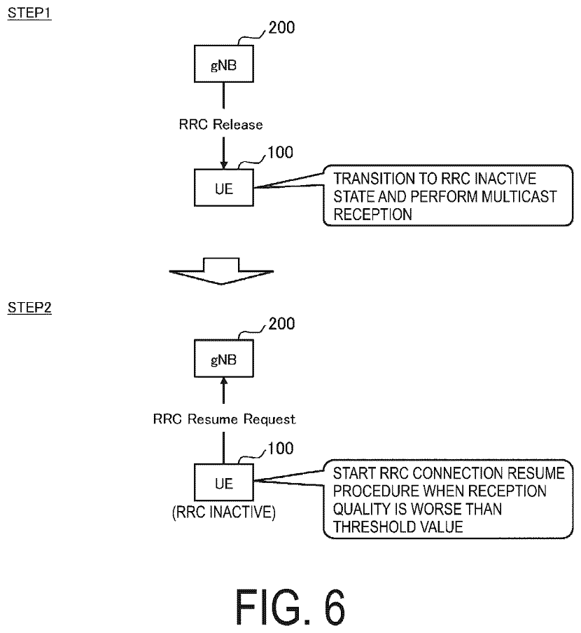

FIG. 6 is a diagram illustrating a first example of the ping-pong phenomenon. In the following description of the embodiment, it is assumed that the UE 100 has already participated in a certain multicast session, and the multicast session is also referred to as a multicast session participated in by the UE 100. “Having participated in the multicast session” may mean a state in which the UE 100 is registered in the network 5 (CN 20) as the UE 100 that receives the multicast session.

In step 1, the gNB 200 transmits, to the UE 100, the RRC release message (that is, the RRC release message including suspend configuration) for causing the UE 100 to transition to the RRC inactive state. The UE 100 transitions from the RRC connected state to the RRC inactive state in response to reception of the RRC release message. The UE 100 may have started multicast reception in the RRC connected state. In the suspend configuration in the RRC release message, the gNB 200 may indicate, to the UE 100, which multicast service (multicast session) is receivable in the RRC inactive state.

The RRC release message transmitted by the gNB 200 may include the multicast reception configuration (the PTM configuration) of the multicast session participated by the UE 100, and the multicast reception configuration may include a threshold value (an RSRP threshold value and/or a RSRQ threshold value). Alternatively, the multicast MCCH transmitted (broadcast) by the gNB 200 may include the multicast reception configuration (the PTM configuration) of each multicast session, and the multicast reception configuration may include a threshold value (the RSRP threshold value and/or the RSRQ threshold value).

In step 2, the UE 100 that performs multicast reception in the RRC inactive state measures reception quality of the serving cell and compares a result of the measurement (a measurement value of RSRP and/or RSRQ) with the threshold value. Here, when reception quality in the UE 100 is worse than the threshold value configured by the network 5, the UE 100 starts the RRC connection resume procedure with respect to the gNB 200 and transmits the RRC resume request (Resume Request) message to the gNB 200. When the RRC connection resume procedure is completed, the UE 100 transitions from the RRC inactive state to the RRC connected state.

For example, when a threshold value configuration by the gNB 200 is inappropriate, and/or when a radio environment in which the UE 100 is located is poor, step 2 may occur immediately after step 1. In this case, an inefficient operation may occur in which the RRC connection resume procedure occurs immediately after the RRC release procedure.

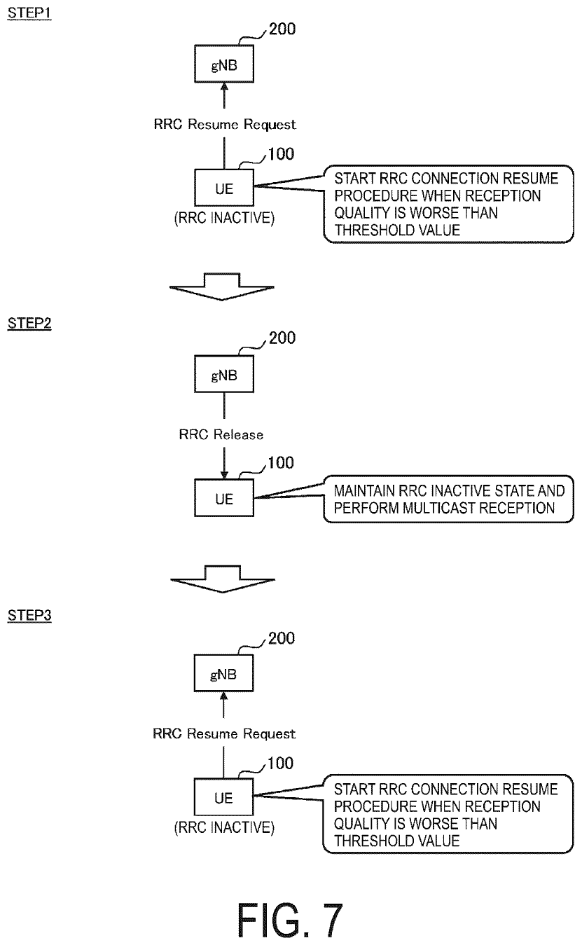

FIG. 7 is a diagram illustrating a second example of the ping-pong phenomenon.

In step 1, the UE 100 that performs multicast reception in the RRC inactive state measures reception quality of the serving cell and compares a result of the measurement (a measurement value of RSRP and/or RSRQ) with the threshold value. Here, when reception quality in the UE 100 is worse than the threshold value configured by the network 5, the UE 100 starts the RRC connection resume procedure with respect to the gNB 200 and transmits a RRC resume request message to the gNB 200.

In step 2, the gNB 200 that has received the RRC resume request message transmits, to the UE 100, the RRC release message including a new multicast reception configuration and suspend configuration. That is, before completion of the RRC connection resume procedure, the gNB 200 provides the new multicast reception configuration to the UE 100 and maintains the UE 100 in the RRC inactive state. The UE 100 applies the new multicast reception configuration, maintains the RRC inactive state, and performs multicast reception. The new multicast reception configuration may include a threshold value configuration.

In step 3, the UE 100 that performs multicast reception in the RRC inactive state measures reception quality of the serving cell and compares a result of the measurement (a measurement value of RSRP and/or RSRQ) with the threshold value. Here, when reception quality in the UE 100 is worse than the threshold value configured by the network 5, the UE 100 starts the RRC connection resume procedure with respect to the gNB 200 and transmits the RRC resume request message to the gNB 200.

For example, when the threshold value configuration by the gNB 200 is inappropriate, and/or when a radio environment in which the UE 100 is located is poor, step 3 may occur immediately after step 2. In this case, an inefficient operation may occur in which the RRC connection resume procedure occurs immediately after the RRC release procedure.

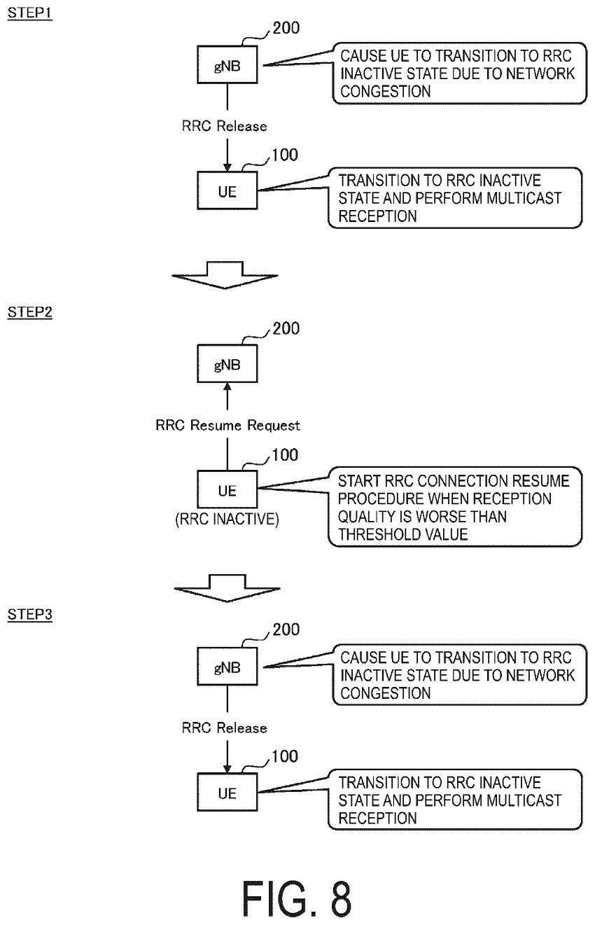

FIG. 8 is a diagram illustrating a third example of the ping-pong phenomenon.

In STEP 1, due to network congestion, the gNB 200 determines to transition the UE 100 performing the multicast reception to the RRC inactive state, and transmits, to the UE 100, the RRC release message (the RRC release message including the suspend configuration). The UE 100 transitions from the RRC connected state to the RRC inactive state in response to reception of the RRC release message. In the suspend configuration in the RRC release message, the gNB 200 may indicate, to the UE 100, which multicast service (multicast session) is receivable in the RRC inactive state.

The RRC release message transmitted by the gNB 200 may include the multicast reception configuration (the PTM configuration) of the multicast session participated by the UE 100, and the multicast reception configuration may include a threshold value (an RSRP threshold value and/or a RSRQ threshold value). Alternatively, the multicast MCCH transmitted (broadcast) by the gNB 200 may include the multicast reception configuration (the PTM configuration) of each multicast session, and the multicast reception configuration may include a threshold value (the RSRP threshold value and/or the RSRQ threshold value).

In step 2, the UE 100 that performs multicast reception in the RRC inactive state measures reception quality of the serving cell and compares a result of the measurement (a measurement value of RSRP and/or RSRQ) with the threshold value. Here, when reception quality in the UE 100 is worse than the threshold value configured by the network 5, the UE 100 starts the RRC connection resume procedure with respect to the gNB 200 and transmits the RRC resume request message to the gNB 200. However, since network congestion has not yet been resolved, the gNB 200 determines to maintain the UE 100 in the RRC inactive state.

In STEP 3, the gNB 200 transmits, to the UE 100, the RRC release message (the RRC release message including a suspend configuration) in order to maintain the UE 100 performing the multicast reception in the RRC inactive state, similarly to STEP 1. In response to the reception of the RRC release message, the UE 100 maintains the RRC inactive state.

Thus, during network congestion, STEP 3 may occur immediately after STEP 2. In this case, an inefficient operation may occur in which the RRC release procedure occurs immediately after the RRC connection resume procedure. Further, STEP 2 may become useless processing.

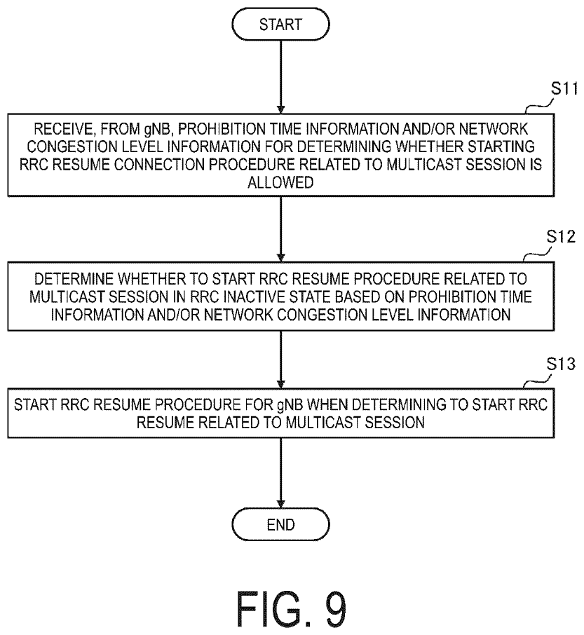

In the following embodiments, an operation capable of suppressing occurrence of the ping-pong phenomenon as described above will be described. FIG. 9 is a diagram illustrating an overview of an operation of the UE 100 according to the embodiment.

In step S11, the UE 100 receives, from the gNB 200, the prohibition period information and/or the network congestion level information for determining whether starting the RRC connection resume procedure related to the multicast session is allowed.

The RRC connection resume procedure related to the multicast session is the RRC connection resume procedure caused by poor reception quality during the multicast reception in the UE 100, or the RRC connection resume procedure caused by a need for the UE 100 to acquire the multicast reception configuration (PTM configuration) from the gNB 200. In the following embodiments, the RRC connection resume procedure caused by poor reception quality during the multicast reception in the UE 100 will be mainly described, but the embodiment may relate to the RRC connection resume procedure caused by a need for the UE 100 to acquire the multicast reception configuration from the gNB 200.

In step S12, in the RRC inactive state, the UE 100 determines whether to start the RRC connection resume procedure related to the multicast session, based on the prohibition period information and/or the network congestion level information of step S11.

In step S13, when the UE 100 determines to start the RRC connection resume procedure related to the multicast session, the UE 100 starts the RRC connection resume procedure for the gNB 200.

Thus, in the embodiment, the UE 100 in the RRC inactive state determines whether to start the RRC connection resume procedure related to the multicast session, based on the prohibition period information and/or the network congestion level information. Thus, the UE 100 can start the RRC connection resume procedure at an appropriate timing, thereby making it possible to suppress occurrence of the ping-pong phenomenon as described above.

The UE 100 performing the operation as illustrated in FIG. 9 includes a receiver 110 that receives, from the gNB 200, the prohibition period information and/or the network congestion level information for determining whether starting the RRC connection resume procedure related to the multicast session is allowed, and a controller 130 that determines whether to start the RRC connection resume procedure based on the prohibition period information and/or the network congestion level information in the RRC inactive state. When the controller 130 determines to start the RRC connection resume procedure, the controller 130 starts the RRC connection resume procedure for the gNB 200.

In a first operation pattern of the embodiment, in step S11, the UE 100 receives, from the gNB 200, an RRC release message including the prohibition period information indicating a period in which starting the RRC connection resume procedure related to the multicast session is prohibited, the RRC release message causing the UE 100 to transition to the RRC inactive state. In step S12, when the period indicated by the prohibition period information has expired, the UE 100 determines that the RRC connection resume procedure related to the multicast session is allowed to start. Thus, from transition to the RRC inactive state to expiration of the period indicated by the prohibition period information, starting the RRC connection resume procedure related to the multicast session is prohibited for the UE 100. Accordingly, the occurrence of the ping-pong phenomenon as described above can be suppressed.

Specifically, in the first operation pattern of the embodiment, in step S12, when the period indicated by the prohibition period information has expired and reception quality during the multicast reception in the UE 100 has degraded and/or a need has arisen for the UE 100 to acquire the multicast reception configuration from the gNB 200, the UE 100 determines to start the RRC connection resume procedure.

In the first operation pattern of the embodiment, the prohibition period information may be associated with a multicast session identifier (MBS session ID). In step S12, when the UE 100 participates in and/or receives a specific multicast session indicated by the multicast session identifier and the period indicated by the prohibition period information has expired, the UE 100 may determine that the RRC connection resume procedure related to the specific multicast session is allowed to start. Thus, by enabling the prohibition period to be configured on a multicast session basis, it is possible to configure the prohibition period only for some multicast sessions and/or to configure different prohibition periods for respective multicast sessions.

In a second operation pattern of the embodiment, in step S11, the UE 100 receives, from the gNB 200, broadcast signaling including the network congestion level information indicating a congestion level of the gNB 200. The broadcast signaling may be an SIB. The SIB may be an SIB for MBS, for example, the above-described SIB20 or SIBx. Alternatively, the broadcast signaling may be a multicast MCCH (a multicast MCCH message). In step S12, when the congestion level (network congestion level) indicated by the network congestion level information is lower than a predetermined level, the UE 100 determines that the RRC connection resume procedure is allowed to start. Thus, the UE 100 can refrain from starting the RRC connection resume procedure related to the multicast session from the transition to the RRC inactive state until the network congestion is resolved (or alleviated). Accordingly, the occurrence of the ping-pong phenomenon as described above can be suppressed.

Specifically, in the second operation pattern of the embodiment, in step S12, when the congestion level (network congestion level) indicated by the network congestion level information is lower than the predetermined level and the reception quality during the multicast reception in the UE 100 has degraded and/or a need has arisen for the UE 100 to acquire the multicast reception configuration from the gNB 200, the UE 100 determines to start the RRC connection resume procedure.

### (3.2) Specific Operation Examples

As specific examples of operation of the mobile communication system 1, the first operation pattern and the second operation pattern will be described. For the first operation pattern and the second operation pattern, each operation pattern may be implemented independently or the two operation patterns may be implemented in combination.

### (3.2.1) First Operation Pattern

In the first operation pattern, the gNB 200 notifies the UE 100, using the RRC release message, of a prohibition period of the RRC resume related to the multicast session. As described above, the RRC resume may relate to degradation in reception quality. The RRC resume may relate to the acquisition of the multicast reception configuration (PTM configuration). The prohibition period may be configured on a multicast session (MBS session ID) basis.

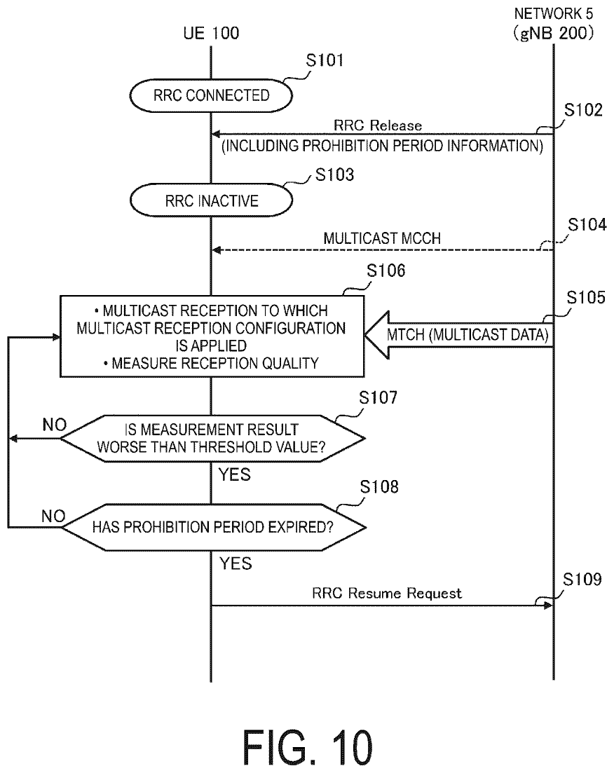

FIG. 10 is a diagram illustrating an example of the first operation pattern of the mobile communication system 1 according to the embodiment.

In step S101, the UE 100 is in the RRC connected state in a cell of the gNB 200.

In step S102, the gNB 200 determines to cause the UE 100 to perform the multicast reception in the RRC inactive state, and transmits, to the UE 100, the RRC release message including the suspend configuration, that is, an RRC release message for causing the UE 100 to transition to the RRC inactive state. The UE 100 receives the RRC release message. The RRC release message may include the multicast reception configuration (the PTM configuration) for multicast reception in the RRC inactive state. The multicast reception configuration may include a threshold value to be compared with multicast reception quality.

In the first operation pattern, the gNB 200 transmits, to the UE 100, the prohibition period information indicating a prohibition period for starting the RRC resume related to the multicast session, by including the prohibition period information in the RRC release message. The prohibition period information may be a timer value corresponding to the prohibition period. When the gNB 200 causes the UE 100 to perform the multicast reception in the RRC inactive state due to network congestion, the gNB 200 may estimate a time for the network congestion to be resolved and determine the prohibition period.

The prohibition period information may be associated with a multicast session identifier (MBS session ID). For example, in the suspend configuration in the RRC release message, the gNB 200 may indicate, to the UE 100, which multicast service (multicast session) is receivable in the RRC inactive state. Here, the gNB 200 may include, in the RRC release message, an MBS session ID of a multicast session for which reception in the RRC inactive state is permitted, and prohibition time information associated with the MBS session ID. Alternatively, when the gNB 200 includes, in the RRC release message, the multicast reception configuration for the multicast session in which the UE 100 has participated, the gNB 200 may include the prohibition time information in the RRC release message in association with the multicast reception configuration. For example, the multicast reception configuration may include an MBS session ID and prohibition time information associated with the MBS session ID.

In step S103, the UE 100 transitions to the RRC inactive state in response to reception of the RRC release message of step S102. When the UE 100 receives the RRC release message in step S102, the UE 100 may start a timer for which the prohibition period (timer value) has been configured. When the UE 100 transitions to the RRC inactive state in step S103, the UE 100 may start the timer for which the prohibition period (timer value) has been configured.

In step S104, the gNB 200 may transmit the multicast MCCH including the multicast reception configuration (the PTM configuration) for multicast reception in the RRC inactive state. The UE 100 may receive the multicast MCCH. The multicast reception configuration may include the threshold value to be compared with multicast reception quality.

In step S105, the gNB 200 transmits the MBS data (multicast data) of the multicast session participated by the UE 100 on MTCH.

In step S106, the UE 100 applies the multicast reception configuration received in step S102 or S104, and performs multicast reception in the RRC inactive state. Specifically, the UE 100 receives the MBS data (multicast data) of the multicast session participated by the UE 100 on MTCH from the gNB 200. Also, the UE 100 measures reception quality (for example, RSRP and/or RSRQ) for the gNB 200 (the serving cell).

In step S107, the UE 100 compares the result of measuring the reception quality in step S106 with the threshold value configured in the multicast reception configuration. When the result of measuring the reception quality in step S106 is not worse than the threshold value (step S107: NO), the UE 100 returns the processing to step S106.

On the other hand, when the reception quality measurement result in step S106 is worse than the threshold value (step S107: YES), the UE 100 determines whether the prohibition period has expired (for example, whether the timer has expired) in step S108. When the prohibition period has not expired (step S108: NO), for example, when the timer is running, the UE 100 returns the processing to step S106 without starting the RRC connection resume procedure.

When the prohibition period has expired (step S108: YES), the UE 100 starts the RRC connection resume procedure and transmits the RRC resume request message to the gNB 200 in step S109. The gNB 200 receives the RRC resume request message.

As a variation of the present operation example, the determination of step S107 and the determination of step S108 may be performed in reverse order. For example, when the prohibition period has not expired, the UE 100 in the RRC inactive state may omit the threshold value determination of the multicast reception quality (step S107) and may perform the threshold value determination of the multicast reception quality (step S107) after the prohibition period has expired.

Further, in the present operation example, in step S107, the UE 100 determines whether starting the RRC connection resume procedure due to the poor reception quality during the multicast reception is necessary. However, in addition to or instead of such a determination, the UE 100 may determine necessity of starting the RRC connection resume procedure due to the need for the UE 100 to acquire the multicast reception configuration from the gNB 200. Alternatively, when the UE 100 receives a group notification (paging message) that is related to the multicast session and includes the MBS session ID of the multicast session in which the UE 100 has participated, the prohibition period may not be applied.

For an RRC resume not related to the multicast session, the prohibition period may not be applied. “Not related to the multicast session” may mean that uplink data has occurred in the UE 100 and/or that the UE 100 has received a normal paging message addressed to the UE 100, similarly to unicast communication of the related art.

### (3.2.2) Second Operation Pattern

In the second operation pattern, the gNB 200 broadcasts the network congestion level information, and the UE 100 determines whether to start the RRC resume in accordance with the network congestion level information.

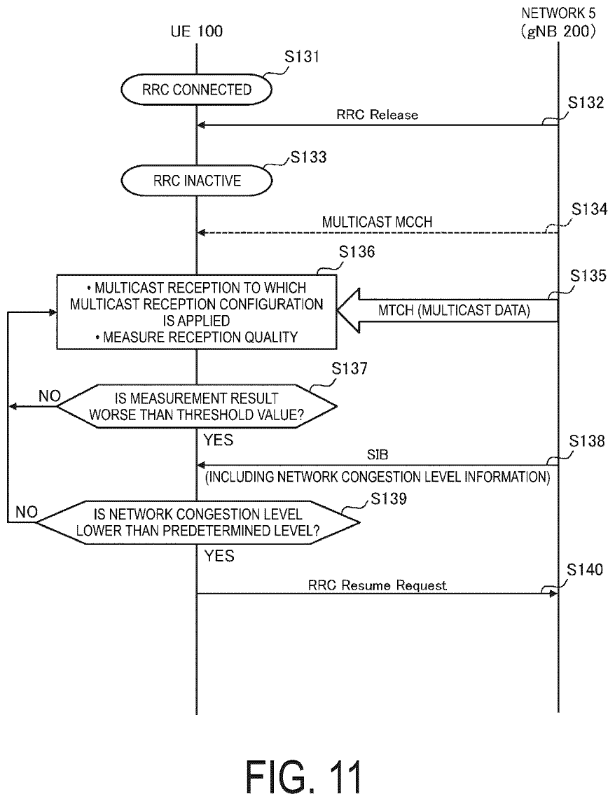

FIG. 11 is a diagram illustrating an example of the second operation pattern of the mobile communication system 1 according to the embodiment.

In step S131, the UE 100 is in the RRC connected state in the cell of the gNB 200.

In step S132, the gNB 200 determines to cause the UE 100 to perform the multicast reception in the RRC inactive state, and transmits, to the UE 100, the RRC release message including the suspend configuration, that is, the RRC release message for causing the UE 100 to transition to the RRC inactive state. The UE 100 receives the RRC release message. The RRC release message may include the multicast reception configuration (the PTM configuration) for multicast reception in the RRC inactive state. The multicast reception configuration may include a threshold value to be compared with multicast reception quality.

In the second operation pattern, the gNB 200 may transmit, to the UE 100, a threshold value to be compared with the network congestion level (also referred to as a “congestion level threshold value”) included in the RRC release message. Hereinafter, a threshold value to be compared with the multicast reception quality is also referred to as a “reception quality threshold value,” to distinguish the threshold value from the congestion level threshold value.

In step S133, in response to the reception of the RRC release message of step S132, the UE 100 transitions to the RRC inactive state.

In step S134, the gNB 200 may transmit the multicast MCCH including the multicast reception configuration (the PTM configuration) for multicast reception in the RRC inactive state. The UE 100 may receive the multicast MCCH. The multicast reception configuration may include the threshold value to be compared with multicast reception quality. In the second operation pattern, the gNB 200 may transmit the congestion level threshold value included in the multicast MCCH. Alternatively, the gNB 200 may transmit the network congestion level information to be described later, which is included in the multicast MCCH.

In step S135, the gNB 200 transmits MBS data (multicast data) of the multicast session in which the UE 100 has participated on the MTCH.

In step S136, the UE 100 applies the multicast reception configuration received in step S132 or S134, and performs the multicast reception in the RRC inactive state. Specifically, the UE 100 receives the MBS data (multicast data) of the multicast session participated by the UE 100 on MTCH from the gNB 200. Also, the UE 100 measures reception quality (for example, RSRP and/or RSRQ) for the gNB 200 (the serving cell).

In step S137, the UE 100 compares the reception quality measurement result in step S136 with the reception quality threshold value configured in the multicast reception configuration. In the present operation example, the UE 100 determines the necessity of starting the RRC connection resume procedure due to poor reception qualities during multicast reception. However, in addition to or instead of such a determination, the UE 100 may determine necessity of starting the RRC connection resume procedure due to the need for the UE 100 to acquire the multicast reception configuration from the gNB 200.

When the reception quality measurement result in step S136 is not lower than the reception quality threshold value (step S137: NO), the UE 100 returns the processing to step S136.

On the other hand, when the reception quality measurement result in step S136 is worse than the threshold value (step S137: YES), the UE 100 receives (acquires), from the gNB 200, the SIB including the network congestion level information in step S138. Here, the gNB 200 transmits (broadcasts) the SIB including the network congestion level information. The network congestion level information may include information of at least one of the following 1) to 3).
1) Information indicating whether the network 5 is congested (1-bit flag information). The information may be information indicating whether the gNB 200 is congested. The information may be information indicating whether the cell of the gNB 200 (the serving cell of the UE 100) is congested.
2) Numerical information indicating a congestion level of the network 5 (or the gNB 200 or the cell). The information may be information indicating the congestion level of the network 5 (or the gNB 200 or the cell) as a percentage (for example, 80%). The congestion level may be a use rate of radio resources. The congestion level may be a use rate of hardware resources.
3) Information indicating whether to permit starting an RRC connection resume related to a multicast session (1-bit flag information). The information may include information indicating whether to permit starting the RRC connection resume due to degradation of the multicast reception quality, and/or information indicating whether to permit starting the RRC connection resume due to acquisition of the multicast reception configuration.

In step S139, the UE 100 determines whether the network congestion level is lower than the predetermined level based on the network congestion level information of step S138.

For example, when the network congestion level information includes information (1-bit flag information) indicating whether the network 5 is congested, the UE 100 may determine that the network congestion level is lower than the predetermined level when the information does not indicate that the network 5 is congested.

When the network congestion level information includes numerical information indicating the congestion level of the network 5 (or the gNB 200 or the cell), the UE 100 may determine that the network congestion level is lower than the predetermined level when the numerical value indicated by the information is lower than the congestion level threshold value.

When the network congestion level information includes the information indicating whether to permit starting then RRC connection resume related to the multicast session (1-bit flag information), the UE 100 may determine that the network congestion level is lower than the predetermined level when the information indicates that starting the RRC connection resume is permitted.

When it is determined that the network congestion level is equal to or higher than the predetermined level (step S139: NO), the UE 100 returns the processing to step S136. Alternatively, the UE 100 may notify the NAS that the network is congested or that the RRC resume cannot be performed in the AS, and start the RRC connection resume for performing the multicast reception through unicast. In this case, the UE 100 transmits the RRC resume request message to the gNB 200 on the assumption that rejection by the gNB 200 occurs.

On the other hand, when it is determined that the network congestion level is lower than the predetermined level (step S139: YES), the UE 100 starts the RRC connection resume procedure and transmits the RRC resume request message to the gNB 200 in step S140. The gNB 200 receives the RRC resume request message.

As a variation of the present operation example, the determination of step S137 and the determination of step S139 may be performed in reverse order. For example, when the network congestion level is equal to or higher than the predetermined level, the UE 100 in the RRC inactive state may omit the threshold value determination of the multicast reception quality (step S137), and perform the threshold value determination of the multicast reception quality (step S137) after the network congestion level becomes lower than the predetermined level.

The second operation pattern may be implemented in combination with the first operation pattern. In this case, the UE 100 may determine that the RRC connection resume procedure is allowed to start only when the prohibition period has expired and the network congestion level is lower than the predetermined level.

### (4) Another Embodiment

Another embodiment will be described mainly with differences from the above embodiment. The present embodiment can be implemented in combination with the above embodiment.

In the present embodiment, an operation capable of suppressing the occurrence of the ping-pong phenomenon as described in FIGS. 7 and 8 will be described. When the UE 100 starts the RRC connection resume in association with the multicast session and the priority of the UE 100 is high, it is desirable for the gNB 200 to cause the UE 100 to transition to the RRC connected state and provide a high-quality service even during network congestion. In the present embodiment, when the UE 100 with high priority starts the RRC connection resume in association with the multicast session, the gNB 200 is enabled to cause the UE 100 to transition to the RRC connected state, and occurrence of the ping-pong phenomenon can be suppressed.

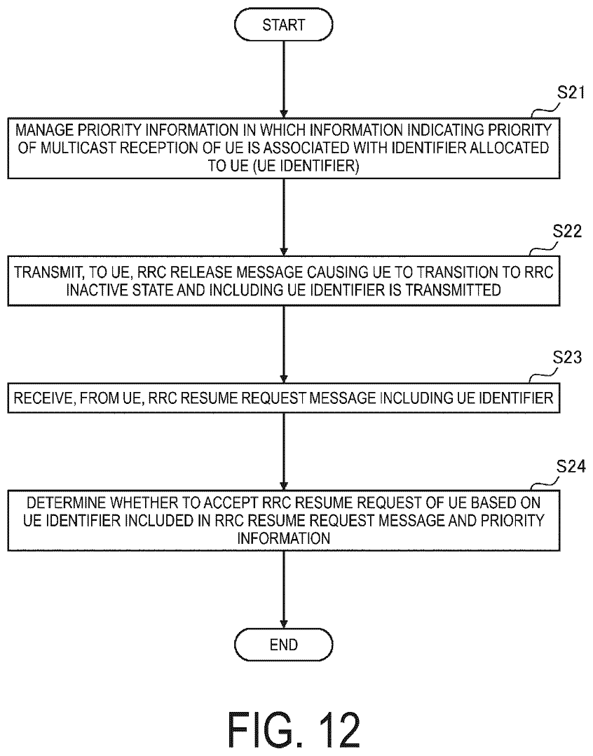

FIG. 12 is a diagram illustrating an overview of an operation of the gNB 200 according to the present embodiment.

In step S21, the gNB 200 manages priority information in which information indicating a priority of the multicast reception of the UE 100 (also referred to as a “multicast priority”) is associated with an identifier assigned to the UE 100. The identifier is an Inactive RNTI (I-RNTI) assigned by the gNB 200 for the UE 100 in the RRC inactive state.

In step S22, the gNB 200 transmits, to the UE 100, an RRC release message causing the UE 100 to transition to the RRC inactive state and including an I-RNTI assigned to the UE 100.

Thereafter, in step S23, the gNB 200 receives the RRC resume request message including the I-RNTI from the UE 100.

In step S24, the gNB 200 determines whether to accept the RRC resume request of the UE 100 in step S23, based on the I-RNTI included in the RRC resume request message of step S23 and the priority information of step S21.

Thus, according to the present embodiment, the gNB 200 can specify the multicast priority of the UE 100 based on the I-RNTI included in the RRC resume request message from the UE 100. Therefore, the gNB 200 can appropriately determine whether to accept the RRC resume request of the UE 100.

The gNB 200 performing the operation as illustrated in FIG. 12 includes a controller 230 that manages the priority information in which information indicating a priority of the multicast reception (the multicast priority) of the UE 100 is associated with the I-RNTI assigned to the UE 100, a transmitter 210 that transmits, to the UE 100, an RRC release message causing the UE 100 to transition to the RRC inactive state and including the I-RNTI, and a receiver 220 that receives, from the UE 100, the RRC resume request message including the I-RNTI. The controller 230 determines whether to accept the RRC resume request of the UE 100 based on the I-RNTI included in the RRC resume request message and the managed priority information.

In the present embodiment, the gNB 200 may receive UE information indicating the multicast priority from a core network apparatus (for example, an AMF 300A), and determine the multicast priority of the UE 100 based on the UE information.

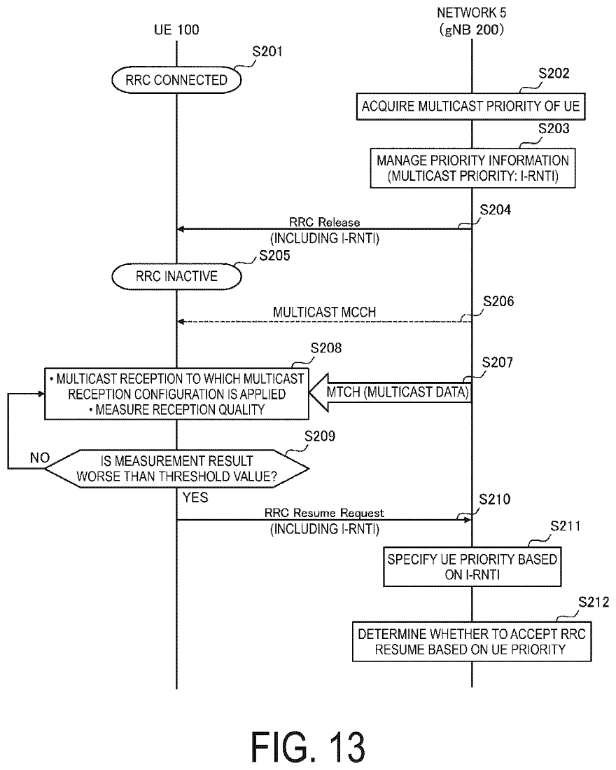

FIG. 13 is a diagram illustrating an example of an operation of the mobile communication system 1 according to the present embodiment. In the present operation example, the gNB 200 acquires, from the AMF 300A, information on the priority of the multicast reception of the UE 100. When the gNB 200 causes the UE 100 to transition to the RRC inactive state, the gNB 200 determines a priority related to the RRC connection resume of the UE 100, and holds, as a UE context, the priority information in which the priority is associated with an I-RNTI.

In step S201, the UE 100 is in the RRC connected state in the cell of the gNB 200.

In step S202, the gNB 200 receives (acquires) the priority information for each UE 100 from the CN 20 (AMF 300A). Here, the AMF 300A transmits the priority information for each UE 100 to the gNB 200 on the NG interface.

For example, the CN 20 (AMF 300A) may refer to subscriber information of each UE 100, set the priority to low when the user contracts the multicast reception as best effort, and set the priority to high when the user has a contract that guarantees service quality (QoS) of the multicast reception.

The CN 20 (AMF 300A) may transmit the priority information for each UE 100 in a UE context setup/update message defined in an application protocol (AP) of the NG interface. The priority information may be, for example, information such as delay-tolerant multicast or low-priority multicast.

In step S203, the gNB 200 determines to cause the UE 100 to perform the multicast reception in the RRC inactive state, determines the priority of the multicast reception of the UE 100 in the RRC connected state (or during RRC resume), and holds the priority as a UE context in association with the I-RNTI.

In step S204, the gNB 200 transmits, to the UE 100, the RRC release message including the suspend configuration, that is, the RRC release message for causing the UE 100 to transition to the RRC inactive state. The suspend configuration includes an I-RNTI assigned to the UE 100. The UE 100 receives the RRC release message and holds the assigned I-RNTI. The RRC release message may include the multicast reception configuration (the PTM configuration) for multicast reception in the RRC inactive state. The multicast reception configuration may include a threshold value to be compared with multicast reception quality.

In step S205, the UE 100 transitions to the RRC inactive state in response to the reception of the RRC release message of step S204.

In step S206, the gNB 200 may transmit the multicast MCCH including the multicast reception configuration (the PTM configuration) for multicast reception in the RRC inactive state. The UE 100 may receive the multicast MCCH. The multicast reception configuration may include the threshold value to be compared with multicast reception quality.

In step S207, the gNB 200 transmits MBS data (multicast data) of the multicast session in which the UE 100 has participated on the MTCH.

In step S208, the UE 100 applies the multicast reception configuration received in step S204 or S206, and performs the multicast reception in the RRC inactive state. Specifically, the UE 100 receives the MBS data (multicast data) of the multicast session participated by the UE 100 on MTCH from the gNB 200. Also, the UE 100 measures reception quality (for example, RSRP and/or RSRQ) for the gNB 200 (the serving cell).

In step S209, the UE 100 compares a reception quality measurement result in step S208 with the reception quality threshold value configured in the multicast reception configuration. In the present operation example, the UE 100 determines the necessity of starting the RRC connection resume procedure due to poor reception qualities during multicast reception. However, in addition to or instead of such a determination, the UE 100 may determine necessity of starting the RRC connection resume procedure due to the need for the UE 100 to acquire the multicast reception configuration from the gNB 200.

When the reception quality measurement result in step S208 is not lower than the reception quality threshold value (step S209: NO), the UE 100 returns the processing to step S208.

On the other hand, when the reception quality measurement result in step S208 is worse than the threshold value (step S209: YES), the UE 100 starts the RRC connection resume procedure and transmits, to the gNB 200, the RRC resume request message including the assigned I-RNTI in step S210. The gNB 200 receives the RRC resume request message.

In step S211, the gNB 200 specifies a UE context from the I-RNTI in the RRC resume request message of step S210 and specifies the priority information of the UE 100.

In step S212, the gNB 200 determines whether to accept the RRC resume request message of step S210, based on the specified priority (the multicast priority). For example, when the multicast priority of the UE 100 is high, the gNB 200 may determine to accept the RRC resume even during network congestion. When the multicast priority of the UE 100 is low, the gNB 200 may determine not to accept the RRC resume during network congestion.

When the gNB 200 accepts the RRC resume, the gNB 200 may transmit an RRC resume message to the UE 100 and receive an RRC resume complete message from the UE 100, thereby causing the UE 100 to transition to the RRC connected state. On the other hand, when the gNB 200 does not accept the RRC resume, the gNB 200 may transmit the RRC release message including the suspend configuration to the UE 100, thereby maintain the UE 100 in the RRC inactive state.

### (5) First Supplement

Although the multicast reception in the RRC inactive state has been mainly described in the above-described embodiments, the operations according to the above-described embodiments may also be applied to multicast reception in the RRC idle state. In the case of the RRC idle state, the above-described RRC resume is replaced with RRC establishment, and the above-described resume cause is replaced with establishment cause.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed. Also, in each flow, an order between steps may be appropriately changed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the gNB 200 may be implemented in a circuitry or a processing circuitry programmed to realize the described functions, including a general-purpose processor, a special-purpose processor, an integrated circuit, application specific integrated circuits (ASICs), a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (6) Second Supplement

Features relating to the above embodiments are supplemented below.

### Supplement 1

A communication method executed by a user equipment in a mobile communication system for providing a multicast broadcast service (MBS), the communication method including the steps of:
receiving, from a network node, prohibition period information and/or network congestion level information for determining whether starting a radio resource control (RRC) connection resume procedure related to a multicast session is allowed;
determining whether to start the RRC connection resume procedure based on the prohibition period information and/or the network congestion level information in an RRC inactive state; and
starting the RRC connection resume procedure for the network node when determining to start the RRC connection resume procedure.

### Supplement 2

The communication method according to supplement 1, wherein
the receiving includes receiving, from the network node, an RRC release message including the prohibition period information indicating a period during which starting the RRC connection resume procedure is prohibited and causing the user equipment to transition to the RRC inactive state, and
the determining includes determining that the RRC connection resume procedure is allowed to start when the period indicated by the prohibition period information has expired.

### Supplement 3

The communication method according to supplement 2, wherein
the determining includes determining to start the RRC connection resume procedure when the period indicated by the prohibition period information has expired and reception quality during the multicast reception in the user equipment has degraded and/or a need has arisen for the user equipment to acquire the multicast reception configuration from the network node.

### Supplement 4

The communication method according to supplement 2 or 3, wherein
the prohibition period information is associated with a multicast session identifier, and the determining includes determining that the RRC connection resume procedure related to a specific multicast session is allowed to start when the user equipment participates in and/or receives the specific multicast session indicated by the multicast session identifier and the period indicated by the prohibition period information has expired.

### Supplement 5

The communication method according to any one of supplements 1 to 4, wherein
the receiving includes receiving, from the network node, broadcast signaling including the network congestion level information indicating a congestion level of the network node, and the determining includes determining that the RRC connection resume procedure is allowed to start when the congestion level is lower than a predetermined level.

### Supplement 6

The communication method according to supplement 5, wherein
the determining includes determining to start the RRC connection resume procedure when the congestion level is lower than the predetermined level and reception quality during the multicast reception in the user equipment has degraded and/or a need has arisen for the user equipment to acquire the multicast reception configuration from the network node.

### Supplement 7

A user equipment used in a mobile communication system for providing a multicast broadcast service (MBS), the user equipment including:
a receiver configured to receive, from a network node, prohibition period information and/or network congestion level information for determining whether starting a radio resource control (RRC) connection resume procedure related to a multicast session is allowed; and
a controller configured to determine whether to start the RRC connection resume procedure based on the prohibition period information and/or the network congestion level information in an RRC inactive state,
wherein, when determining to start the RRC connection resume procedure, the controller starts the RRC connection resume procedure for the network node.

### Supplement 8

A communication method executed by a network node in a mobile communication system for providing a multicast broadcast service (MBS), the communication method including the steps of:
managing priority information in which information indicating a priority of the multicast reception of a user equipment is associated with an identifier assigned to the user equipment; transmitting, to the user equipment, an RRC release message causing the user equipment to transition to a radio resource control (RRC) inactive state and including the identifier;
receiving, from the user equipment, the RRC resume request message including the identifier; and
determining whether to accept an RRC resume request of the user equipment based on the identifier included in the RRC resume request message and the priority information.

### Supplement 9

The communication method according to supplement 8, further including the steps of:
receiving, from a core network apparatus, user equipment information indicating the priority of the multicast reception; and
determining the priority of the multicast reception based on the user equipment information.

### Supplement 10

A network node used in a mobile communication system for providing a multicast broadcast service (MBS), the network node including:
a controller configured to manage priority information in which information indicating a priority of the multicast reception of a user equipment is associated with an identifier assigned to the user equipment;
a transmitter configured to transmit, to the user equipment, a radio resource control (RRC) release message causing the user equipment to transition to an RRC inactive state and including the identifier;
a receiver configured to receive, from the user equipment, the RRC resume request message including the identifier; and
wherein the controller determines whether to accept an RRC resume request of the user equipment based on the identifier included in the RRC resume request message and the priority information.

### (7) Third Supplement

### 1. Introduction

A work item regarding enhancement of MBS (eMBS) is intended to support multicast reception in the UE in the inactive state as follows:
To define support for multicast reception by the UE in the RRC inactive state [RAN2, RAN3]
The PTM configuration for the UE that receives multicast in the RRC inactive state [RAN2].
investigating impacts of mobility and state transition of the UE that receives multicast in the

RRC inactive state. (Seamless/lossless mobility is not mandatory) [RAN2, RAN3].

In this supplement, details of the RRC resume due to bad quality and causes of resume are discussed.

### 2. Discussion

### 2.1. RRC Resume Due to Bad Reception Quality

RAN2 #123 agreed to introduce RSRP/RSRQ-based RRC resume as follows.

In the UE that receives multicast in the RRC inactive state, when RSRP or RSRQ measured based on an existing measurement requirement (as configured by NW) of the serving cell becomes lower than the threshold value configured by the network, the UE resumes the RRC connection. Further study is needed on whether it is necessary to address a ping-pong issue.

The threshold value can be PTM-configured per MBS session via the RRC release or the multicast MCCH message.

Based on agreements, remaining issues are discussed in the following section.

### 2.1.1. Ping-Pong Issue

The agreements are obtained by capturing discussion items regarding “whether it is necessary to address the ping-pong issue and/or how to address the ping-pong issue.” As scenarios for resuming a ping-pong operation, the following can be considered:
1. The UE in the inactive state with deteriorating radio quality starts RRC resume when RSRP/RSRQ becomes worse than a threshold value.
2. In response to the RRC resume request, the gNB under NW congestion transmits the RRC release with suspend config. including the RSRP/RSRQ threshold value.
3. The UE with still-deteriorated radio quality transitions to the inactive state again, and since RSRP/RSRQ immediately becomes lower than the threshold value, RRC resume is started again.

In order to avoid ping-pong in the above scenario, it can be considered that the gNB maintains the UE in the connected state or sets an appropriate RSRP/RSRQ threshold value for the UE.

In order to support such a determination, the gNB is likely to need to ascertain a radio condition and/or a reason for RRC resume (in this case, due to deterioration of radio quality) as soon as the UE requests RRC resume.

Finding 1: The gNB is likely to need to ascertain the radio condition of the UE and the reason for RRC resume when the UE requests RRC resume in order to guarantee QoS requirements.

According to discussion in RAN2 at an early stage of Release 18, it should be noted that two main motivations for supporting multicast reception in the inactive state are NW congestion mitigation and UE power consumption. Therefore, it is not reasonable that, each time the UE requests RRC resume, the gNB always keeps the UE in the connected state and configures measurement reporting.

Finding 2: Since motivations for supporting multicast reception in the inactive state are NW congestion mitigation and UE power saving, it is not reasonable to rely on measurement reporting for guaranteeing of the QoS requirements.

In consideration of the above findings, it is useful that, when the UE starts the RRC resume due to deterioration of reception quality in the RRC resume procedure, that is, in the RRC resume request or an RRC resume complete, the UE reports measurement results. Another option is that the UE notifies deterioration of radio wave state in the resume causes. With such information, the gNB can make an appropriate determination as to whether to maintain the UE in the connected state for QoS guarantee.

Proposal 1: RAN 2 should agree that measurement results are reported in the RRC resume procedure, or that a new resume cause “Multicast quality” is introduced.

### 2.1.2. Validity of RSRP/RSRQ Threshold Configured by the RRC Release

RAN2 agreed that “a threshold value can be configured in the PTM configuration per MBS session based on an the RRC release or the multicast MCCH message.” In the case of dedicated configuration provided by RRC release, many configurations are valid until a corresponding timer expires. For example, dedicated frequency priority is valid until T320 expires. This occurs regardless of cell reselection, and after the UE reselects a target cell, dedicated configuration provided from a source cell is valid.

Finding 3: According to current specifications, many dedicated configurations are valid until the timer expires regardless of the cell reselection.

As for the RSRP/RSRQ threshold value, when it is valid after the cell reselection, an issue is likely to occur assuming the following conditions:
In the source cell, since the PTM is transmitted with a low MCS, the UE has set a low RSRP threshold value in order to guarantee certain reception quality.
In a target cell after the cell reselection, the PTM is transmitted with a higher MCS, but the UE keeps applying the old RSRP threshold value.
As a result, the UE causes an MTCH reception error even though RSRP is still better than an old threshold value.

In order to avoid this issue, considering that PTM transmission of NR MBS is cell-specific, the RSRP/RSRQ threshold value should be cell-specific. That is, when the UE reselects a different cell, an old RSRP/RSRQ threshold value should be discarded.

Proposal 2: RAN 2 should agree that the RSRP/RSRQ threshold value is discarded upon the cell reselection.

Another issue that may be considered in processing the RSRP/RSRQ threshold value is that, when threshold values are provided from both the RRC release and the multicast MCCH, the UE needs to determine which threshold value should be applied. In a current specification, generally, dedicated configuration provided by the RRC release is prioritized over a configuration provided by an SIB. However, in the case of multicast reception in the inactive state, RAN2 agreed that “In a case in which it is necessary to change the PTM configuration, MCCH is used when it is necessary to indicate the PTM configuration,” that is, the PTM configuration provided by the RRC release is likely to be changed by the PTM configuration provided by the multicast MCCH. This means that, since the RSRP/RSRQ threshold value is overwritten by the multicast MCCH, threshold value cannot be configured as a UE-specific configuration, that is, a TMGI-specific configuration.

Proposal 3: RAN 2 needs to confirm that the PTM configuration including the RSRP/RSRQ threshold value provided by the RRC release is always overwritten by configuration provided by the multicast MCCH, that is, there is no UE-specific configuration for multicast reception in the inactive state.

### 2.1.3. Other Confirmation Matters

RAN2 #123 agreed that “for the UE that receives multicast in the RRC inactive state, when measured RSRP or RSRQ[. . . ] of the serving cell becomes lower than a threshold value [. . . ], the UE resumes the RRC connection.” The threshold value of RSRP/RSRQ is introduced for QoS guarantee of multicast reception in the inactive state.

On the other hand, when the multicast session is deactivated by the network, the UE in an inactive state may not receive MTCH (or may temporarily not receive data) when the session is deactivated. In this case, since the UE is regarded as the same as a legacy UE in the inactive state, RRC resume due to bad quality (the RSRP/RSRQ threshold value) is not necessary. Although the above agreements have already been suggested, it is necessary to confirm that, even when RSRP/RSRQ deteriorates below a threshold value, a UE in an inactive state does not start the RRC resume when a multicast session is inactive (deactivated) (or when there is temporarily no data).

Proposal 4: RAN 2 needs to confirm that the UE in the inactive state does not start the RRC resume even when RSRP/RSRQ becomes worse than the threshold value in a case in which the multicast session is deactivated (or there is temporarily no data).

In RAN2 #123, RAN2 has discussed whether the threshold value can be based on BLER, but finally RAN2 has determined that RSRP/RSRQ is adopted.

On the other hand, in Release 17, it was a common understanding of RAN2 that single frequency network (SFN) is deployable, for example, only in the DU due to NW implementation. In SFN between cells, by combining receptions from MTCH of different cells, reception quality is stable even at a cell edge. However, RSRP/RSRQ is cell-specific, and deteriorates at a cell edge when leaving the SFN. Therefore, the RSRP/RSRQ threshold value does not work well in SFN deployment, but the BLER threshold value can avoid such an issue.

Proposal 5: RAN 2 needs to confirm that SFN (single frequency network) allowed in Release 17 by the NW implementation does not operate with the RSRP/RSRQ threshold value in Release 18.

### 2.2. Resume Cause

RAN2 #123 agreed that, in Release 18, for RRC resume due to some reasons as well as deterioration of reception quality discussed in the previous section, existing resume causes are reused. However, analysis is still needed regarding which existing resume cause is applied and whether a new resume cause is truly unnecessary.

Unless an issue is specified in using one of existing resume causes, a new resume cause is not introduced for a UE receiving MC in an inactive state when resuming is performed due to bad quality or lack of the SIBx/the PTM configuration.

Currently, 11 resume causes are defined with five spare fields below.

ResumeCause::=ENUMERATED {emergency, highPriorityAccess, mt-Access, mo-Signalling, mo-Data, mo-VoiceCall, mo-VideoCall, mo-SMS, rna-Update, mps-PriorityAccess, mcs-PriorityAccess, spare1, spare2, spare3, spare4, spare5}

Similarly to Finding 2 above, one of motivations of the multicast reception in the inactive state is network congestion mitigation. Therefore, the analysis needs to consider a case in which the network becomes congested.

Finding 4: Mapping between RRC resume for multicast reception and existing resume causes needs to consider a congestion condition of the network.

Typical determinations of the gNB when receiving the RRC resume request under network congestion are classified as follows:
always accept an emergency;
prioritize highPriorityAccess, mps-PriorityAccess, and mcs-PriorityAccess;
accept mt-Access and mo-Signalling (as much as possible);
may reject mo-Data, mo-VoiceCall, mo-VideoCall, and mo-SMS;
respond a new RNA with RRC release for rna-Update.

Finding 5: By resume, the gNB can determine whether to accept, reject, or release with a new RNA in response to the RRC resume request particularly in the case of NW congestion.

RAN2 agreed that the UE starts RRC resume in two cases: “due to bad quality” or “due to lack of the SIBx/the PTM configuration.” From a viewpoint of impact on a network load, features of these reasons differ as follows:
As discussed in Section 2.1.1, in the case of the RRC resume due to bad quality, when the UE is released while still being in the inactive state again, the QoS requirements are no longer guaranteed, and thus the UE needs to be maintained in the connected state. Considering that the UE needs to be maintained in the connected state, the UE does not consume additional downlink resources (because the UE only receives PTM already transmitted to other UEs), but consumes uplink resources (such as HARQ ACK). When a network is congested, the UE consumes slightly more resources compared to the multicast reception in the inactive state, but still this may be prioritized over a resume request of a unicast service. In other words, the gNB may prioritize the RRC resume request for multicast reception over the RRC resume request for unicast reception, but the gNB may still reject the RRC resume request due to severe congestion.
In the case of the RRC resume due to lack of the SIBx/the PTM configuration, when a radio condition is good, the UE can be released in the PTM configuration, that is, in the RRC resume, to receive the multicast session. Therefore, this is “light” in terms of network congestion, that is, the UE consumes almost no downlink resource/uplink resource. In other words, the NW can immediately accept the RRC resume request on the premise of the RRC release accompanied by the PTM configuration of RRC resume.

Finding 6: Since the gNB affects the NW congestion to some extent in order to maintain the UE in the connected state when the NW is congested, the gNB may reject RRC resume due to bad quality.

Finding 7: Due to lack of the SIBx/the PTM configuration, the gNB can accept the RRC resume and immediately release the UE with the PTM configuration. This is because the NW congestion is not affected.

In consideration of the above discussion, the RRC resume due to bad quality is likely to be mapped to any of mo-Data, mo-VoiceCall, mo-VideoCall, or mo-SMS. However, since multicast reception in connected does not require additional PDSCH resources (that is, PTM is already provided to other UEs), current gNB implementation with respect to such existing resume cause is likely to be affected when a different type of communication (that is, multicast reception only) is mapped to an existing resume cause.

For RRC resume due to lack of the SIBx/the PTM configuration, since there is a new intent of RRC resume accompanied by the PTM configuration, there is no resume cause to be mapped. Although a similar gNB determination is assumed in rna-Update, the gNB provides RNA instead of the PTM configuration for RRC resume. That is, the gNB cannot transmit the RRC release with the PTM configuration in response to the RRC resume request, and the gNB may erroneously reject the UE request even though the UE only requests the PTM configuration update without impact on NW congestion.

Finding 8: There is no existing resume cause that conforms to a gNB determination expected in the case of the RRC resume request due to bad quality or due to lack of the SIBx/the PTM configuration.

RAN2 has actually identified a possibility of new resume causes in the following discussion.

Resume causes:
1. Multicast quality
2. Multicast configuration

The two resume causes can easily solve all issues discussed above without potentially impacting current gNB implementation. As also discussed above, the two resume causes are effective for the gNB to appropriately derive different results. Therefore, two new resume causes should be introduced appropriately.

Since it is highly expected that 3GPP will start consideration of 6G from Release 20, it is expected that 5G NR evolves only for two releases in the future (that is, up to Release 20 at most). Considering a history of additional resume in past releases, three resume in Release 18 are sufficient.

Proposal 6: RAN 2 should agree on a new resume cause “Multicast quality” configured when RRC resume is started due to bad quality. The determination of the expected gNB is prioritized over MO data, or the like.

Proposal 7: RAN 2 should agree on a new resume cause “multicast configuration” configured when RRC resume is started due to lack of the SIBx/the PTM configuration. The determination of the expected gNB is to respond with an RRC release accompanied by the PTM configuration.

### REFERENCE SIGNS

1: Mobile communication system
5: Network
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method executed by a user equipment in a mobile communication system for providing a multicast broadcast service (MBS), the communication method comprising:
receiving, from a network node, prohibition period information and/or network congestion level information for determining whether starting a radio resource control (RRC) connection resume procedure related to a multicast session is allowed;
determining whether to start the RRC connection resume procedure based on the prohibition period information and/or the network congestion level information in an RRC inactive state; and
starting the RRC connection resume procedure for the network node when determining to start the RRC connection resume procedure.

2. The communication method according to claim 1, wherein
the receiving comprises receiving, from the network node, an RRC release message comprising the prohibition period information indicating a period during which starting the RRC connection resume procedure is prohibited and causing the user equipment to transition to the RRC inactive state, and
the determining comprises determining that the RRC connection resume procedure is allowed to start when the period indicated by the prohibition period information has expired.

3. The communication method according to claim 2, wherein
the determining comprises determining to start the RRC connection resume procedure when the period indicated by the prohibition period information has expired and reception quality during the multicast reception in the user equipment has degraded and/or a need has arisen for the user equipment to acquire the multicast reception configuration from the network node.

4. The communication method according to claim 2, wherein
the prohibition period information is associated with a multicast session identifier, and
the determining comprises determining that the RRC connection resume procedure related to a specific multicast session is allowed to start when the user equipment participates in and/or receives the specific multicast session indicated by the multicast session identifier and the period indicated by the prohibition period information has expired.

5. The communication method according to claim 1, wherein
the receiving comprises receiving, from the network node, broadcast signaling comprising the network congestion level information indicating a congestion level of the network node, and
the determining comprises determining that the RRC connection resume procedure is allowed to start when the congestion level is lower than a predetermined level.

6. The communication method according to claim 5, wherein
the determining comprises determining to start the RRC connection resume procedure when the congestion level is lower than the predetermined level and reception quality during the multicast reception in the user equipment has degraded and/or a need has arisen for the user equipment to acquire the multicast reception configuration from the network node.

7. A user equipment used in a mobile communication system for providing a multicast broadcast service (MBS), the user equipment comprising:
a receiver configured to receive, from a network node, prohibition period information and/or network congestion level information for determining whether starting a radio resource control (RRC) connection resume procedure related to a multicast session is allowed; and
a controller configured to determine whether to start the RRC connection resume procedure based on the prohibition period information and/or the network congestion level information in an RRC inactive state,
wherein, when determining to start the RRC connection resume procedure, the controller starts the RRC connection resume procedure for the network node.

8. A communication method executed by a network node in a mobile communication system for providing a multicast broadcast service (MBS), the communication method comprising:
managing priority information in which information indicating a priority of the multicast reception of a user equipment is associated with an identifier assigned to the user equipment;
transmitting, to the user equipment, a radio resource control (RRC) release message causing the user equipment to transition to an RRC inactive state and comprising the identifier;
receiving, from the user equipment, the RRC resume request message comprising the identifier; and
determining whether to accept an RRC resume request of the user equipment based on the identifier included in the RRC resume request message and the priority information.

9. The communication method according to claim 8, further comprising:
receiving, from a core network apparatus, user equipment information indicating the priority of the multicast reception; and
determining the priority of the multicast reception based on the user equipment information.
